(19) United States
(12) Patent Application Publication
(10) Pub. No.: US 2026/0264216 A1
(43) Pub. Date: Sep. 10, 2026

(54) TOOL DEVICE, TOOL, AND METHOD OF USING TOOL DEVICE

(71) Applicant: NAGAKI SEIKI CO., LTD., Osaka (JP)

(72) Inventors: Takashi MIYAKO, Wakabayashi-ku, Sendai-shi, Miyagi (JP); Keitarou OBA, Miyagi (JP); Shingo KIMURA, Osaka (JP); Junji TANAKA, Osaka (JP); Naoki SAIJO, Osaka (JP)

(21) Appl. No.: 19/167,187

(22) PCT Filed: Mar. 15, 2024
(86) PCT No.: PCT/JP2024/010154

§ 371 Date: Sep. 19, 2025

(30) Foreign Application Priority Data
Mar. 20, 2023 (JP) 2023-043971

(51) Int. Cl. B25J 1/12; B25J 13/00; B25J 19/00

(52) U.S. Cl. CPC B25J 1/12; B25J 13/006; B25J 19/0004

(57) ABSTRACT

An object is to provide a tool device, a tool, and a method of using a tool device that can facilitate approach of the tool to a target. The tool device includes: an expandable first rod member; and a tool attached to the first rod member. The tool includes an attachment part attached to the first rod member, an arm supported pivotably by the attachment part, an end effector supported by the arm and configured to cause force to act on a force application target, an arm drive device configured to pivot the arm with respect to the attachment part, and an end effector drive device configured to drive the end effector, and thereby the object can be achieved.

### TECHNICAL FIELD

The present invention relates to a tool device, a tool, and a method of using a tool device.

### BACKGROUND ART

A technique to expand a rod member to which a tool is attached and thereby cause the tool to come close to an electrical wire or the like is known.

As a related art, Patent Literature 1 discloses an arm device. The arm device disclosed in Patent Literature 1 includes a base part provided to a bucket of an aerial work platform and a retractable arm part provided to the base part. The arm part has a first arm part, which is retractable with respect to the base part, and a second arm part, which is provided to the first arm part and is retractable with respect to the first arm part in a direction parallel to a direction in which the first arm part advances and retracts. A tool can be attached to the second arm part.

### CITATION LIST

### Patent Literature

Patent Literature 1: Japanese Patent Application Laid-Open No. 2018-34931

### SUMMARY OF INVENTION

### Technical Problem

Patent Literature 1 illustrates a configuration in which the arm part can be linearly retractable with respect to the base part and a configuration in which the arm part can be tilted with respect to the base part. Since this tilting motion takes place on the base part side, this results in a long motion distance of a tool due to the tilting motion. This results in high difficulty in the operation to cause a tool to approach a target by using this tilting motion. Further, since the tilting motion takes place on the base part side, this results in low flexibility in the direction in which a tool is caused to approach a target. In other words, the direction in which the tool is caused to approach a target is undesirably fixed to a single direction by the positional relationship between the bucket and the target. Thus, there is a problem of higher difficulty in the operation to cause a tool to approach a target in a situation where an obstacle is present around the target or the like.

Accordingly, the object of the present invention is to provide a tool device, a tool, and a method of using a tool device that can facilitate approach of the tool to a target.

### Solution to Problem

The present invention relates to a tool device, a tool, and a method of using a tool device illustrated below.
(1) A tool device including:
an expandable first rod member; and
a tool attached to the first rod member,
wherein the tool comprises
an attachment part attached to the first rod member,
an arm supported pivotably by the attachment part,
   an end effector supported by the arm and configured to cause force to act on a force application target,
an arm drive device configured to pivot the arm with respect to the attachment part, and
an end effector drive device configured to drive the end effector.
(2) The tool device according to (1) above, wherein the tool includes
a communication unit configured to communicate with a remote controller, and
   a control circuit configured to control the arm drive device and the end effector drive device based on a signal received by the communication unit.
(3) The tool device according to (2) above,
wherein the communication unit is configured to wirelessly communicate with the remote controller,
wherein the first rod member is an electrically insulating rod member, and
wherein the tool is a tool for electrical construction.
(4) The tool device according to any one of (1) to (3) above further including:
a second rod member; and
   a first connection part connecting the second rod member and the first rod member to each other,
wherein the first connection part connects the second rod member and the first rod member to each other so that an angle between the first rod member and the second rod member is changeable.
(5) The tool device according to (4) above, wherein the angle between the first rod member and the second rod member is manually changeable.
(6) The tool device according to (4) above, wherein the first connection part includes
a lock mechanism configured to prevent the first rod member from tilting with respect to the second rod member, and
an unlocking manipulation part configured to release locking applied by the lock mechanism.
(7) The tool device according to (4) above, wherein the first connection part includes a tilting speed suppressing mechanism configured to suppress the tilting speed of the first rod member with respect to the second rod member when the first rod member tilts with respect to the second rod member due to the gravity acting on the tool or the first rod member.
(8) The tool device according to (4) above further including:
a holding part provided to the first connection part and configured to hold the first rod member; and
a first manipulation part configured to change the state of the holding part between a first state where the first rod member is held by the holding part and a second state where holding of the first rod member by the holding part is released.
(9) The tool device according to (4) above, wherein the first rod member is supported by the second rod member via the first connection part so as to be rotatable about the central axis of the second rod member.
(10) The tool device according to any one of (1) to (3) above,
wherein the tool includes a gripping mechanism configured to grip the force application target,
wherein the gripping mechanism has
a first grip part, and
   a second grip part driven by the end effector drive device and movable relative to the first grip part, and
wherein the end effector includes the gripping mechanism.
(11) The tool device according to any one of (1) to (3) above,
wherein the tool is driven by the end effector drive device and has a rotating body rotatable about a first rotation axis, and
wherein the end effector includes the rotating body.
(12) The tool device according to any one of (1) to (3) above, wherein the tool includes a tool holding part provided separately from the end effector and configured to detachably hold another tool.
(13) A tool including:
an attachment part configured to be attached to a rod member;
an arm supported pivotably by the attachment part;
   an end effector supported by the arm and configured to cause force to act on a force application target;
an arm drive device configured to pivot the arm with respect to the attachment part; and
an end effector drive device configured to drive the end effector.
(14) A method of using a tool device,
wherein the tool device includes
an expandable first rod member, and
a tool attached to the first rod member, and
wherein the tool includes
an attachment part attached to the first rod member,
an arm supported pivotably by the attachment part,
an end effector supported by the arm,
an arm drive device configured to pivot the arm with respect to the attachment part, and
an end effector drive device configured to drive the end effector,
the method including:
   an approach step of causing the tool to approach a target by performing at least one of: expanding the first rod member; and pivoting the arm with respect to the attachment part by using the arm drive device;
a position adjustment step of adjusting the position of the tool by the first rod member being manually manipulated; and
a force application step of applying force to a force application target from the end effector by using the end effector drive device to drive the end effector.

### Advantageous Effects of Invention

According to the present invention, it is possible to provide a tool device, a tool, and
a method of using a tool device that can facilitate approach of the tool to a target.

### BRIEF DESCRIPTION OF DRAWINGS

FIG. 1 is a general perspective view schematically illustrating a tool device of a first embodiment.

FIG. 2 represents general side views schematically illustrating the tool device of the first embodiment.

FIG. 3 represents general side views schematically illustrating the tool device of the first embodiment.

FIG. 4 is a general side view schematically illustrating a tool device of a second embodiment.

FIG. 5 represents general side views schematically illustrating a portion of the tool device of the second embodiment.

FIG. 6 represents diagrams schematically illustrating an example of a lock mechanism.

FIG. 7 is a general perspective view schematically illustrating a portion of the tool device of the second embodiment.

FIG. 8 is a general front view schematically illustrating a portion of the tool device of the second embodiment.

FIG. 9 is a diagram schematically illustrating a portion of a tilting speed suppressing mechanism.

FIG. 10 is a general side view schematically illustrating the tool device of the second embodiment.

FIG. 11 is a general perspective view schematically illustrating a portion of the tool device of the second embodiment.

FIG. 12 represents diagrams schematically illustrating an example of a holding part.

FIG. 13 represents general plan views schematically illustrating the tool device of the second embodiment.

FIG. 14 represents general side views schematically illustrating a portion of the tool device of the second embodiment.

FIG. 15 represents general front views schematically illustrating a portion of the tool device of the second embodiment.

FIG. 16 is a general side view schematically illustrating a portion of a tool device of a first modified example of the second embodiment.

FIG. 17 is a general side view schematically illustrating a portion of a tool device of a second modified example of the second embodiment.

FIG. 18 is a general side view schematically illustrating a portion of the tool device of the second embodiment.

FIG. 19 is a general side view schematically illustrating a tool of a third embodiment.

FIG. 20 is a diagram schematically illustrating a view during a position adjustment step being performed.

FIG. 21 is a flowchart illustrating an example of a method of using a tool device of an embodiment.

### DESCRIPTION OF EMBODIMENTS

A tool device 1, a tool 2, and a method of using the tool device 1 of the embodiment will be described below in detail with reference to the drawings. Note that, in the present specification, members having the same type of functions are labeled with the same or similar references. Further, for the members labeled with the same or similar references, duplicated description thereof may be omitted.

### First Embodiment

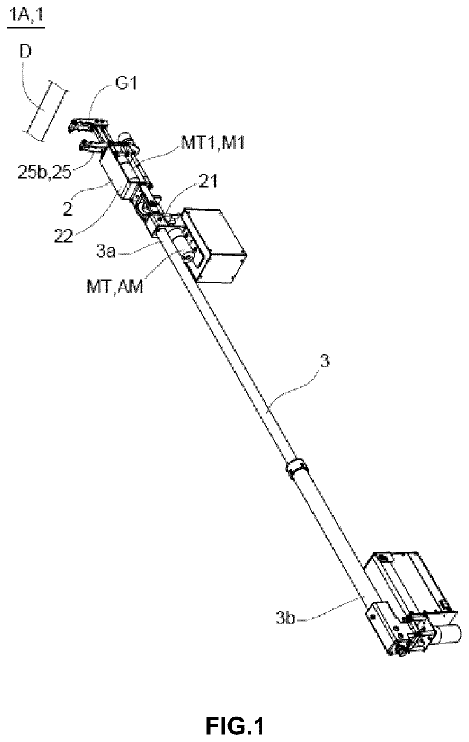

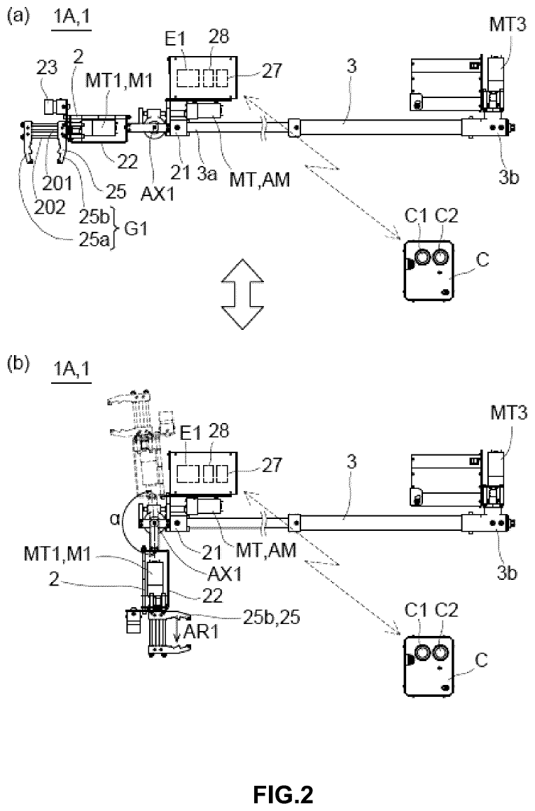

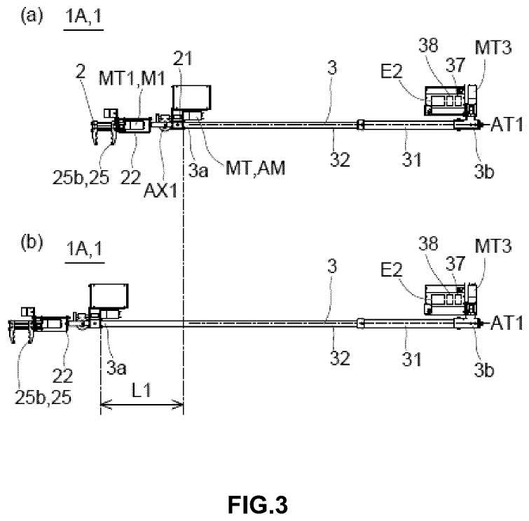

A tool device 1A of a first embodiment will be described with reference to FIG. 1 to FIG. 3. FIG. 1 is a general perspective view schematically illustrating the tool device 1A of the first embodiment. FIG. 2 and FIG. 3 are general side views schematically illustrating the tool device 1A of the first embodiment.

As illustrated in FIG. 1 as an example, the tool device 1A of the first embodiment includes a first rod member 3 and a tool 2 attached to the first rod member 3.

The first rod member 3 is expandable. Expansion of the first rod member 3 enables the tool 2 to approach a target D. The target D is, for example, an overhead electrical wire or otherwise other tools. In the embodiment, however, the target D may be any object without being limited to overhead electrical wires or other tools.

When the first rod member 3 is contracted, the tool 2 comes close to a proximal end 3b of the first rod member 3. In such a case, carrying the tool device 1A is facilitated. Further, since the tool 2 comes close to an operator, an adjustment operation performed on the tool 2 by the operator (for example, an operation to attach another tool to the tool 2) is facilitated. Note that, although the operator is expected to be on the proximal end side of the first rod member 3, no operator may be present when the tool device 1A is a fully automated device.

For example, the first rod member 3 is made of FRP (in other words, made of a fiber reinforced composite material). When the tool 2 is a tool for electrical construction, it is preferable that the first rod member 3 be an electrically insulating rod member.

The tool 2 has an attachment part 21, an arm 22, an end effector 25, an arm drive device AM (more specifically, an arm drive motor MT), and an end effector drive device M1 (more specifically, a first motor MT1).

The attachment part 21 is attached to the first rod member 3. In the example illustrated in FIG. 1, the attachment part 21 is attached to a distal end 3a of the first rod member 3. The attachment part 21 is formed of a plurality of components.

The arm 22 is pivotably supported by the attachment part 21. The arm 22 may be formed of a single component or may be formed of a plurality of components.

The end effector 25 is supported by the arm 22. The end effector 25 causes force to act on a force application target. For example, when the end effector 25 includes a gripping mechanism G1, the end effector 25 causes gripping force to act on a force application target. Further, when the end effector 25 includes a rotation part having a hook or the like, the end effector 25 causes rotational force to act on a force application target. For example, when the force application target is a manipulation ring of another tool, the end effector 25 causes rotation force to act on the manipulation ring to rotate the manipulation ring. The end effector 25 may be formed of a single component or may be formed of a plurality of components. Note that, in the present specification, the end effector means a mechanical element that causes any force such as gripping force, cutting force, manipulation force, or the like to act on a target.

In the example illustrated in FIG. 1, the target D to which the tool 2 is to be caused to come close and the force application target to which force is to be applied from the end effector 25 are the same. Alternatively, the target D and the force application target may differ from each other. For example, another tool may be gripped by the end effector 25 of the tool 2, and this another tool may be caused to approach an electrical wire. In such a case, “another tool” is the force application target to which force is applied from the end effector 25, and “electrical wire” is the target D.

The arm drive device AM pivots (more specifically, tilts) the arm 22 with respect to the attachment part 21. The arm 22 is pivoted with respect to the attachment part 21 by drive force from the arm drive device AM, and thereby the tool 2 can be caused to approach the target D.

The end effector drive device M1 drives the end effector 25. The end effector 25 is driven by the end effector drive device M1, and thereby the end effector 25 can cause force to act on the force application target.

The tool device 1A of the first embodiment includes the first rod member 3, the attachment part 21 attached to the first rod member 3, the arm 22 pivotable with respect to the attachment part 21, and the end effector 25 supported by the arm 22. In such a case, the use of expansion and contraction of the first rod member 3 and pivoting of the arm 22 can facilitate approach of the tool 2 to the target D. Because the arm 22 is pivotable with respect to the attachment part 21, it is possible to cause the tool 2 to approach the target D (for example, an electrical wire) from the back side of the target D, for example.

The tool device 1A of the first embodiment includes the arm drive device AM that pivots the arm 22 with respect to the attachment part 21. In such a case, even when the tool 2 has a large mass (otherwise, even when another tool supported by the tool 2 has a large mass), it is possible to easily pivot the arm 22 with respect to the attachment part 21. Further, the tool device 1A of the first embodiment includes the end effector drive device M1 that drives the end effector 25. In such a case, regardless of the position of the tool 2 or the attitude of the tool 2, it is possible to use the end effector drive device M1 to cause desired force to act on the force application target from the end effector 25.

Further, in the tool device 1A of the first embodiment, since at least a part of the operation is performed by the drive device (M1, AM), a desired operation can be accomplished with the use of the tool 2 of the tool device 1A by few operators or in an unmanned manner.

Further, because the arm drive device AM is arranged to the tool 2, the drive force transfer system that transfers drive force from the arm drive device AM to the arm 22 can be made compact. Further, because the end effector drive device M1 is arranged to the tool 2, the drive force transfer system that transfers drive force from the end effector drive device M1 to the end effector 25 can be made compact.

Next, optional, additional configurations that can be employed in the tool device 1A of the first embodiment (otherwise, a tool device 1B of a second embodiment described later or a tool 2 of a third embodiment described later) will be described with reference to FIG. 2 and FIG. 3.

### Communication Unit 27 and Control Circuit 28

In this specification, illustration (a) in FIG. 2 may be referred to as FIG. 2(a), and illustration (b) in FIG. 2 may be referred to as FIG. 2(b). As illustrated in FIG. 2(a) as an example, the tool 2 may have a communication unit 27 and a control circuit 28.

The communication unit 27 can communicate with a remote controller C. Further, the control circuit 28 controls the arm drive device AM and the end effector drive device M1 based on signals received from the remote controller C by the communication unit 27. The control circuit 28 may be included in a control chip or may be included in a small computer.

When the tool 2 includes the communication unit 27 and the control circuit 28, the operator is able to use the remote controller C to remotely manipulate the tool 2.

In the example illustrated in FIG. 2(a), when an arm manipulation part C1 of the remote controller C is manipulated, the remote controller C transmits a first manipulation signal to the communication unit 27, and the control circuit 28 controls the arm drive device AM based on the first manipulation signal received by the communication unit 27. In such a way, the arm drive device AM pivots the arm 22 with respect to the attachment part 21 (see FIG. 2(b)). Further, in the example illustrated in FIG. 2(a), when an end effector manipulation part C2 of the remote controller C is manipulated, the remote controller C transmits a second manipulation signal to the communication unit 27, and the control circuit 28 controls the end effector drive device M1 based on the second manipulation signal received by the communication unit 27. In such a way, the end effector drive device M1 drives the end effector 25 (see the arrow AR1 in FIG. 2(b)). In the example illustrated in FIG. 2, the operator is able to pivot the arm 22 and drive the end effector 25 by simply manipulating the remote controller C.

It is preferable that the communication unit 27 can wirelessly communicate with the remote controller C. When the communication between the communication unit 27 and the remote controller C is wireless communication, no communication line is required to be arranged along the first rod member 3. In such a case, since there is no need for cabling a communication line along the first rod member 3 in association with attaching the tool 2 to the first rod member 3, it is possible to assemble the tool device 1A with few man-hours. Further, since no communication line is arranged along the first rod member 3, even when the tool 2 is a tool for electrical construction, no current from an electrical wire is conducted to the proximal end 3b of the first rod member 3 via a communication line. Thus, the operator is prevented from getting electric shock. For example, when the first rod member 3 is an electrically insulating rod member, the operator is reliably prevented from getting electric shock.

### First Battery E1

In the example illustrated in FIG. 2(a), the tool 2 has a first battery E1 that supplies power to the arm drive device AM and the end effector drive device M1. When the tool 2 includes the communication unit 27 and the control circuit 28, the first battery E1 supplies power to the communication unit 27 and the control circuit 28 in addition to the arm drive device AM and the end effector drive device M1. The first battery E1 may be formed of a single battery or may be formed of a plurality of batteries.

### Pivoting of Arm 22 About First Axis AX1

In the example illustrated in FIG. 2(a), the arm 22 is supported by the attachment part 21 so as to be pivotable about the first axis AXI with respect to the attachment part 21. In the example illustrated in FIG. 2(a), the arm 22 is pivotable about only the first axis AX1, which is a single axis, with respect to the attachment part 21. Further, in the example illustrated in FIG. 2(a), the first axis AXI is an axis perpendicular to the longitudinal direction of the first rod member 3. Alternatively, the arm 22 may be supported by the attachment part 21 via a universal joint. In such a case, the arm 22 is pivotable about any axis with respect to the attachment part 21.

In the example illustrated in FIG. 2(b), the movable angle a of the arm 22 relative to the attachment part 21 about the first axis AX1 may be less than 360 degrees and, more specifically, is around 180 degrees. Alternatively, the arm 22 may be rotatable by 360 degrees about the first axis AXI with respect to the attachment part 21.

### Expansion and Contraction of First Rod Member 3

In this specification, illustration (a) in FIG. 3 may be referred to as FIG. 3(a), and illustration (b) in FIG. 3 may be referred to as FIG. 3(b). In the example illustrated in FIG. 3(a), the tool device 1A includes a third motor MT3 that expands and contracts the first rod member 3. Alternatively, the expansion and contraction of the first rod member 3 may be manually performed.

In the example illustrated in FIG. 3(a), driving of the third motor MT3 is performed based on the instruction from the remote controller C. It is preferable that the tool device 1A include a second communication unit 37 that can communicate with the remote controller C and a second control circuit 38 that controls the third motor MT3 based on signals received from the remote controller C by the second communication unit 37.

In the example illustrated in FIG. 3(a), the first rod member 3 has a first shaft 31 having the proximal end 3b and a second shaft 32 having the distal end 3a. A part of the second shaft 32 has been inserted inside the first shaft 31. Further, the second shaft 32 is movable relative to the first shaft 31 in a direction parallel to the central axis AT1 of the first rod member 3 by driving of the third motor MT3 (otherwise, manually).

In the example illustrated in FIG. 3(a), a part of the first shaft 31 and a part of the second shaft 32 are overlapped with each other, and no other shaft is arranged between the first shaft 31 and the second shaft 32. In other words, the first rod member 3 is formed of two shafts. In such a case, the length of the first rod member 3 is a length obtained by subtracting the length of the overlapping portion between the first shaft 31 and the second shaft 32 from the sum of the length of the first shaft 31 and the length of the second shaft 32. Alternatively, the first rod member 3 may be a rod member that is expandable in multiple steps (in other words, the first rod member 3 may be formed of three or more shafts that are movable relative to each other).

The expansion and contraction of the first rod member 3 by driving of the third motor MT3 may be performed by using a ball screw mechanism, may be performed by using a rack and pinion, or may be performed by using other mechanisms.

FIG. 3(a) illustrates a state where the first rod member 3 is most contracted, and FIG. 3(b) illustrates a state where the first rod member 3 is most expanded. The difference between the length of the first rod member 3 in the most expanded state and the length of the first rod member 3 in the most contracted state (in other words, the telescopic stroke L1 of the first rod member 3) is preferably, for example, 10 cm or greater, 20 cm or greater, or 30 cm or greater. Further, the telescopic stroke LI is preferably, for example, 300 cm or less, 200 cm or less, or 100 cm or less.

In the example illustrated in FIG. 3(a), the tool device 1A has a second battery E2 that supplies power to the third motor MT3. When the tool device 1A includes the second communication unit 37 and the second control circuit 38, the second battery E2 supplies power to the second communication unit 37 and the second control circuit 38 in addition to the third motor MT3.

### Second Embodiment

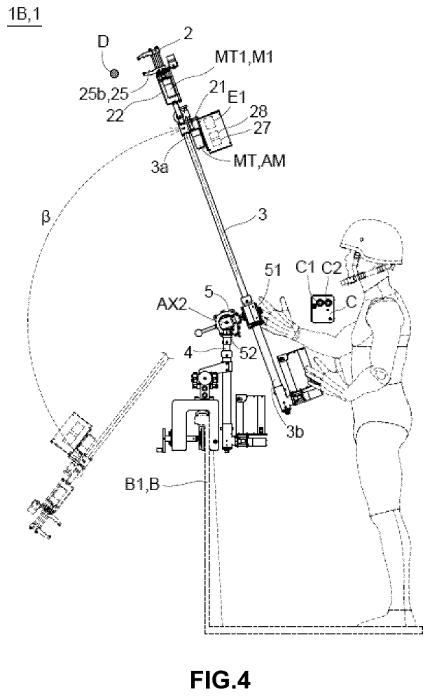

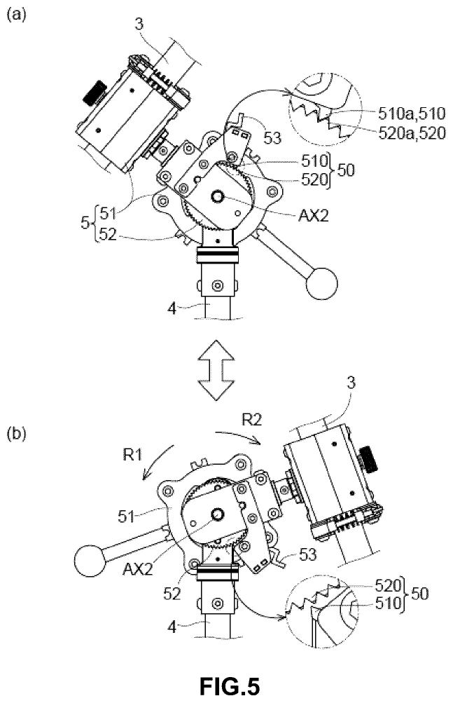

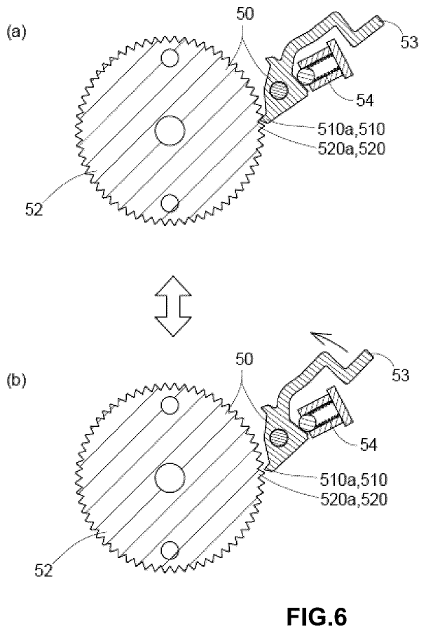

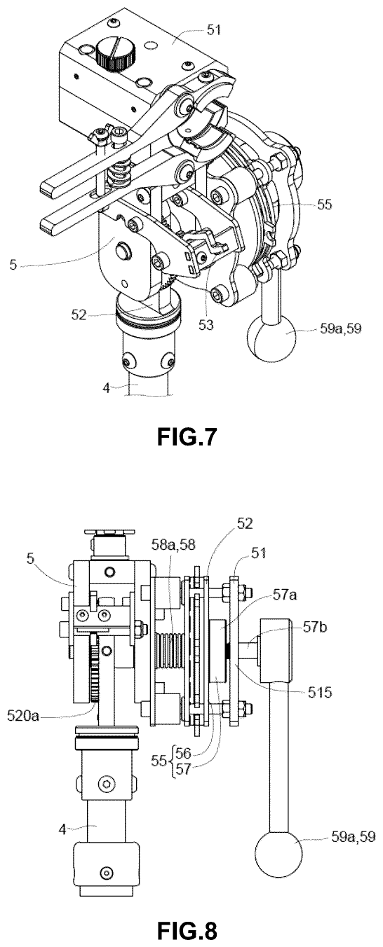

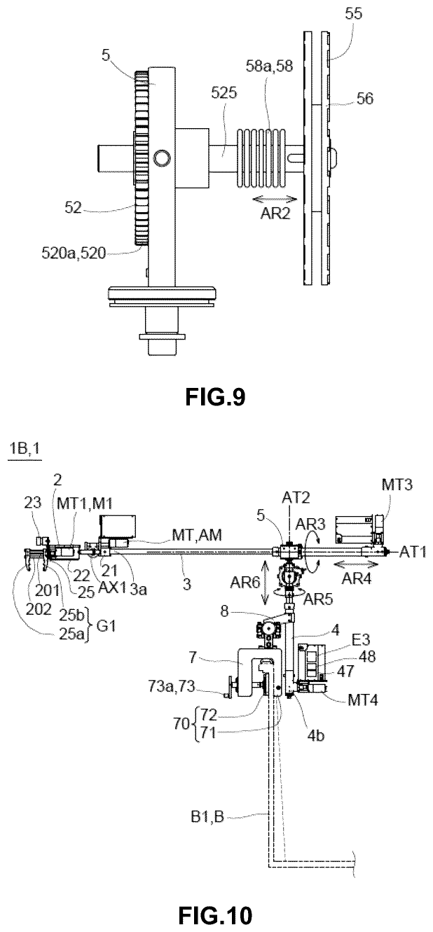

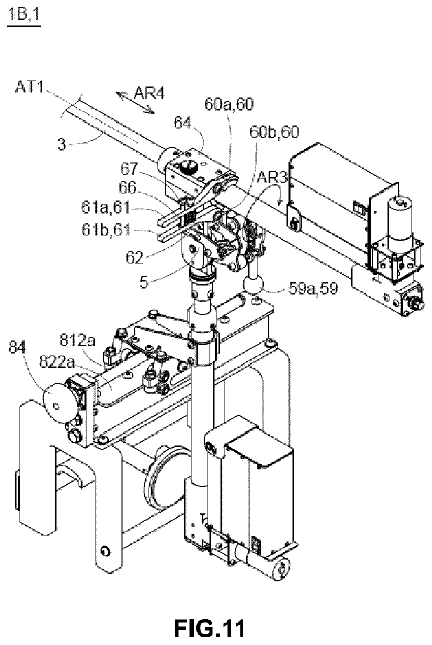

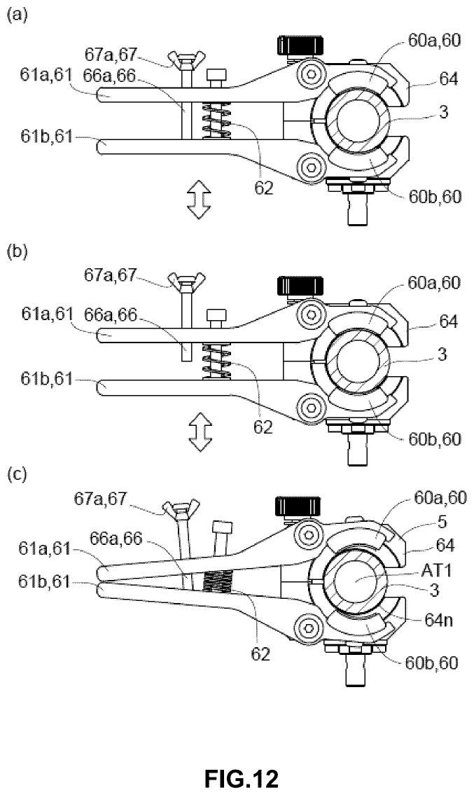

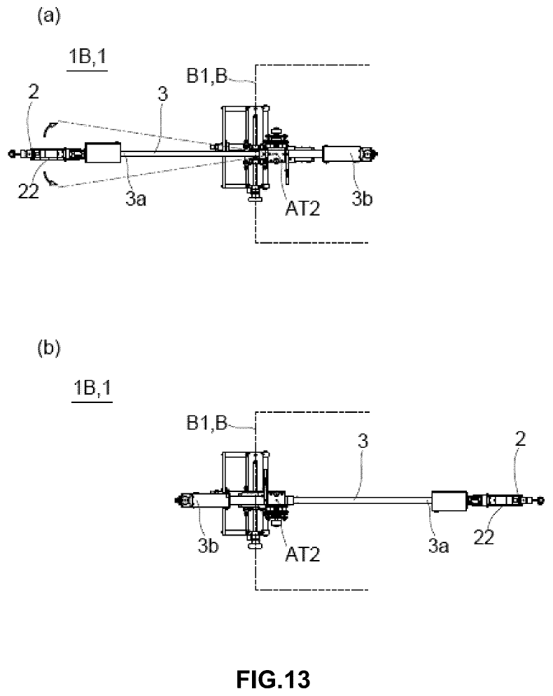

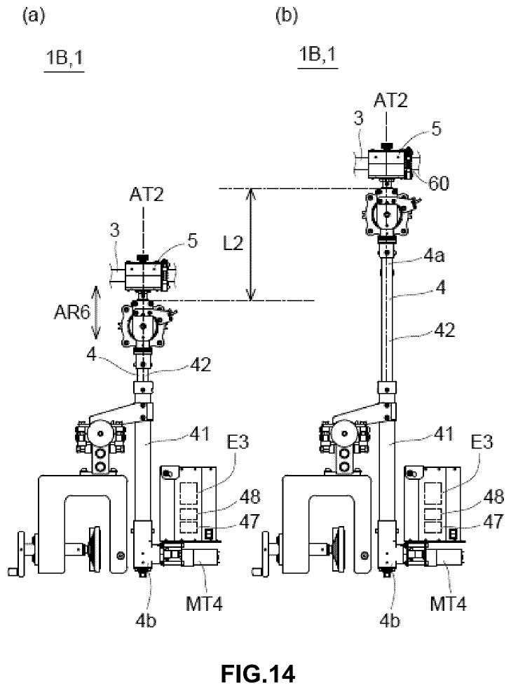

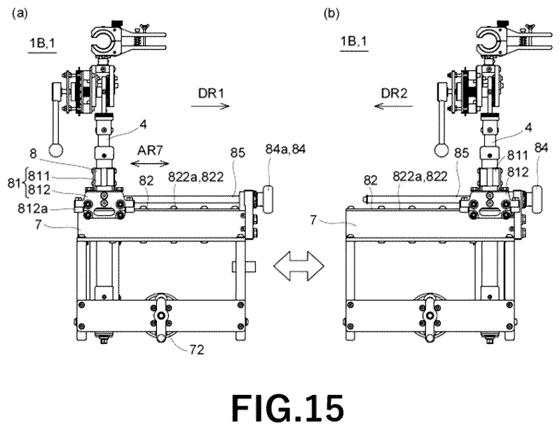

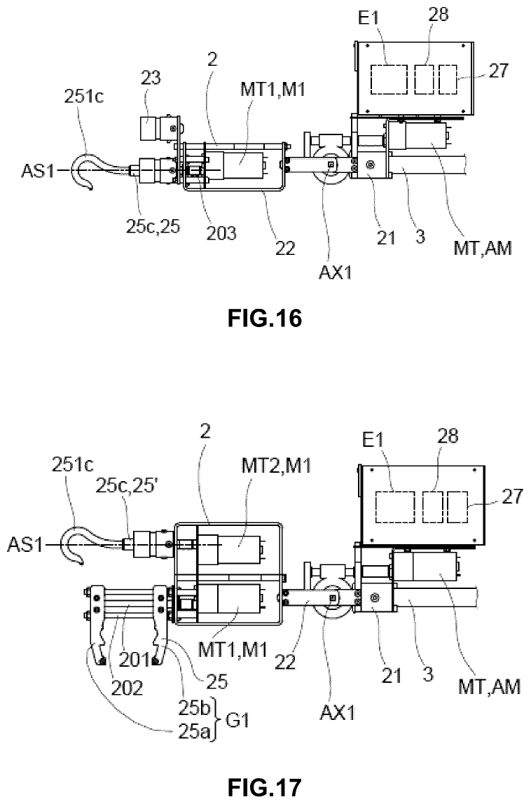

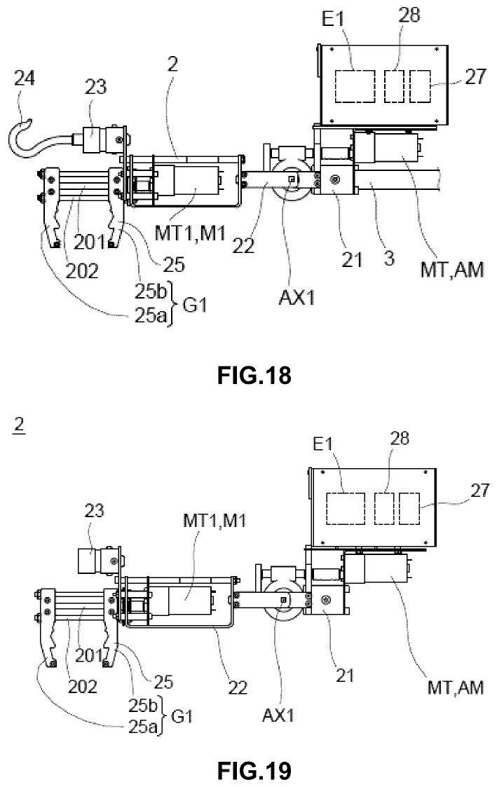

A tool device 1B of a second embodiment will be described with reference to FIG. 4 to FIG. 18. FIG. 4 is a general side view schematically illustrating the tool device 1B of the second embodiment. Note that, in FIG. 4, a fixing target B to which the tool device 1B is fixed and the operator are illustrated by dashed lines. FIG. 5 represents general side views schematically illustrating a portion of the tool device 1B of the second embodiment. FIG. 6 represents diagrams schematically illustrating an example of a lock mechanism 50. FIG. 7 is a general perspective view schematically illustrating a portion of the tool device 1B of the second embodiment. FIG. 8 is a general front view schematically illustrating a portion of the tool device 1B of the second embodiment. FIG. 9 is a diagram schematically illustrating a portion of a tilting speed suppressing mechanism 55. FIG. 10 is a general side view schematically illustrating the tool device 1B of the second embodiment. FIG. 11 is a general perspective view schematically illustrating a portion of the tool device 1B of the second embodiment. FIG. 12 represents diagrams schematically illustrating an example of a holding part 60. FIG. 13 represents general plan views schematically illustrating the tool device 1B of the second embodiment. FIG. 14 represents general side views schematically illustrating a portion of the tool device 1B of the second embodiment. FIG. 15 represents general front views schematically illustrating a portion of the tool device 1B of the second embodiment. FIG. 16 is a general side view schematically illustrating a portion of the tool device 1B of a first modified example of the second embodiment. FIG. 17 is a general side view schematically illustrating a portion of the tool device 1B of a second modified example of the second embodiment. FIG. 18 is a general side view schematically illustrating a portion of the tool device 1B of the second embodiment.

The tool device 1B of the second embodiment differs from the tool device 1A of the first embodiment in that the tool device 1B includes a second rod member 4 and the like in addition to the tool 2 and the first rod member 3.

In the second embodiment, features different from the first embodiment will be mainly described, and duplicated description for features that have already been described in the first embodiment will be omitted. It is therefore obvious that, even when not explicitly described in the second embodiment, the features that have already been described in the first embodiment can be employed in the second embodiment.

### Second Rod Member 4

In the example illustrated in FIG. 4, the tool device 1B includes a second rod member 4. For example, the second rod member 4 is made of FRP (in other words, made of a fiber reinforced composite material). Further, the tool device 1B includes a first connection part 5 connecting the second rod member 4 and the first rod member 3 to each other. The first connection part 5 connects the second rod member 4 and the first rod member 3 to each other so that the angle between the first rod member 3 and the second rod member 4 is changeable.

When the tool device 1B includes the second rod member 4 and the first connection part 5 and the angle between the first rod member 3 and the second rod member 4 is changeable, this increases the number of choices of paths used for causing the tool 2 to approach the target D.

As illustrated in FIG. 4 as an example, it is preferable that the angle between the first rod member 3 and the second rod member 4 be manually changeable. When the angle between the first rod member 3 and the second rod member 4 is manually changeable, it is possible to quickly adjust the position of the tool 2. For example, let us assume a case where the position of the tool 2 did not reach a desired position near the target D even with expansion of the first rod member 3 or pivoting of the arm 22 or a case where the position of the target D is moved by an external turbulence such as wind. In such a case, by manually changing the angle between the first rod member 3 and the second rod member 4, it is possible to quickly adjust the position of the tool 2 toward the position of the target D or in accordance with the positional change of the target D.

As illustrated in FIG. 4 as an example, let us assume a case where the angle between the first rod member 3 and the second rod member 4 is manually changeable and the tool 2 includes the communication unit 27 that can communicate with the remote controller C and the control circuit 28 that controls the arm drive device AM and the end effector drive device M1 based on signals received by the communication unit 27. In such a case, it is possible to, while supporting the proximal end 3b of the first rod member 3 by one hand and adjusting the angle of the first rod member 3 relative to the second rod member 4, manipulate the remote controller C by the other hand to pivot (more specifically, tilt) the arm 22 with respect to the first rod member 3.

Next, optional, additional configurations that can be employed in the tool device 1B of the second embodiment (otherwise, the tool device 1A of the first embodiment or the tool 2 of the third embodiment described later) will be described with reference to FIG. 4 to FIG. 18.

### Pivoting of First Rod Member 3 About Second Axis AX2

In the example illustrated in FIG. 4, the first rod member 3 is connected to the second rod member 4 via the first connection part 5 so as to be rotatable relative to the second rod member 4 about a second axis AX2. In the example illustrated in FIG. 4, the second axis AX2 is an axis perpendicular to the longitudinal direction of the second rod member 4. Further, the second axis AX2 is an axis perpendicular to the longitudinal direction of the first rod member 3. Alternatively, the first rod member 3 may be supported by the second rod member 4 via a universal joint form first connection part. In such a case, the first rod member 3 is pivotable about any axis with respect to the second rod member 4.

In the example illustrated in FIG. 4, a variable angle β of the first rod member 3 relative to the second rod member 4 about the second axis AX2 is less than 360 degrees, less than 180 degrees, more specifically around 120 degrees. Alternatively, the first rod member 3 may be rotatable by 360 degrees about the second axis AX2 with respect to the second rod member 4.

The first rod member 3 and the second rod member 4 may be configured such that it is possible to set the longitudinal direction of the first rod member 3 to be parallel to the vertical direction (more specifically, it may be possible to position the distal end 3a of the first rod member 3 vertically above the proximal end 3b of the first rod member 3) by rotating the first rod member 3 about the second axis AX2 in a state where the second rod member 4 is arranged along the vertical direction. Further, the first rod member 3 and the second rod member 4 may be configured such that it is possible to set the longitudinal direction of the first rod member 3 to be parallel to the horizontal direction by rotating the first rod member 3 about the second axis AX2 in a state where the second rod member 4 is arranged along the vertical direction.

### First Connection Part 5

In the example illustrated in FIG. 4, the first connection part 5 connects the first rod member 3 and the second rod member 4 to each other so that the first rod member 3 can be tilted about the second axis AX2 with respect to the second rod member 4.

The first connection part 5 has a first portion 51 attached to the first rod member 3 and a second portion 52 attached to the second rod member 4. Further, the first portion 51 is coupled to the second portion 52 so as to be pivotable with respect to the second portion 52. In the example illustrated in FIG. 4, the first portion 51 is formed of a plurality of components, and the second portion 52 is formed of a plurality of components.

In this specification, illustration (a) in FIG. 5 may be referred to as FIG. 5(a), and illustration (b) in FIG. 5 may be referred to as FIG. 5(b). As illustrated in FIG. 5(a) as an example, the first connection part 5 may include a lock mechanism 50, which prevents the first rod member 3 from being tilted with respect to the second rod member 4, and the unlocking manipulation part 53, which unlocks locking applied by the lock mechanism 50. In the example illustrated in FIG. 5(a), the lock mechanism 50 prevents the first rod member 3 from being rotated about the second axis AX2 with respect to the second rod member 4.

The lock mechanism 50 has a first engagement part 510 (for example, a claw 510a) and a second engagement part 520 (for example, a gear wheel 520a) engageable to the first engagement part 510. A state where the first engagement part 510 and the second engagement part 520 are engaged to each other (see FIG. 5(a)) corresponds to a locked state where the first rod member 3 is prevented from being rotated about the second axis AX2 with respect to the second rod member 4, and a state where engagement between the first engagement part 510 and the second engagement part 520 is released (see FIG. 5(b)) corresponds to an unlocked state. The engagement between the first engagement part 510 and the second engagement part 520 is released by the unlocking manipulation part 53 being manipulated. In the example illustrated in FIG. 5(a), the first engagement part 510 and the unlocking manipulation part 53 are provided to the first portion 51 described above, and the second engagement part 520 is provided to the second portion 52.

When the first connection part 5 includes the lock mechanism 50, the angle between the first rod member 3 and the second rod member 4 does not vary even when the operator releases its hand from the first rod member 3. Further, when the first connection part 5 has the unlocking manipulation part 53, the angle between the first rod member 3 and the second rod member 4 can be changed after locking applied by the lock mechanism is released.

Note that, in the locked state described above, rotation of the first rod member 3 in the first rotation direction R1 about the second axis AX2 with respect to the second rod member 4 may be inhibited, and rotation of the first rod member 3 in the second rotation direction R2 (the second rotation direction R2 opposite to the first rotation direction R1) about the second axis AX2 may be allowed. For example, in the locked state described above, it may be inhibited that the first rod member 3 is rotated about the second axis AX2 so that the distal end 3a of the first rod member 3 is moved downward, and it may be allowed that the first rod member 3 is rotated about the second axis AX2 so that the distal end 3a of the first rod member 3 is moved upward. For example, the gear wheel 520a may be configured as a ratchet wheel, thereby the rotation of the first rod member 3 in the first rotation direction R1 is inhibited, and the rotation of the first rod member 3 in the second rotation direction R2 may be allowed.

Alternatively, in the locked state described above, rotation of the first rod member 3 in the first rotation direction R1 about the second axis AX2 with respect to the second rod member 4 may be inhibited, and rotation of the first rod member 3 in the second rotation direction R2 (the second rotation direction R2 opposite to the first rotation direction R1) about the second axis AX2 may also be inhibited.

In this specification, illustration (a) in FIG. 6 may be referred to as FIG. 6(a), and illustration (b) in FIG. 6 may be referred to as FIG. 6(b). In the example illustrated in FIG. 6(a), the first connection part 5 has a pushing member 54 (more specifically, a spring) that pushes one of the first engagement part 510 and the second engagement part 520 in a direction toward the other of the first engagement part 510 and the second engagement part 520. In such a case, in a state where the unlocking manipulation part 53 is not being manipulated, the first engagement part 510 and the second engagement part 520 are engaged with each other by the pushing force from the pushing member 54. As illustrated in FIG. 6(b), however, when the unlocking manipulation part 53 is manipulated, the first engagement part 510 and the second engagement part 520 are spaced apart from each other against the pushing force from the pushing member 54, and the engagement between the first engagement part 510 and the second engagement part 520 is released.

### Tilting Speed Suppressing Mechanism 55

In a state where locking applied by the lock mechanism 50 described above is released (otherwise, when the tool device 1B does not include the lock mechanism 50), once the operator releases its hand from the first rod member 3, the first rod member 3 may be tilted at a high speed about the second axis AX2 (see FIG. 4) due to the gravity acting on the tool 2 or the first rod member 3. Accordingly, in the example illustrated in FIG. 7, the first connection part 5 includes the tilting speed suppressing mechanism 55 that suppresses the tilting speed of the first rod member 3 with respect to the second rod member 4 when the first rod member 3 is tilted with respect to the second rod member 4 due to the gravity acting on the tool 2 or the first rod member 3. It is preferable that the tilting speed suppressing mechanism 55 be a mechanism that suppresses the tilting speed of the first rod member 3 about the second axis AX2 (see FIG. 4) with respect to the second rod member 4. Note that, although the first rod member 3 is not explicitly illustrated in FIG. 7, the first rod member 3 is attached to the first portion 51 during the use of the tool device 1B.

In the example illustrated in FIG. 8, the tilting speed suppressing mechanism 55 has a friction plate 56 and a pressing member 57 that presses the friction plate 56. One of the friction plate 56 and the pressing member 57 is provided to the first portion 51, and the other of the friction plate 56 and the pressing member 57 is provided to the second portion 52. In such a case, due to contact between the friction plate 56 and the pressing member 57, the rotational speed of the first portion 51 relative to the second portion 52 is suppressed, and the tilting speed of the first rod member 3 attached to the first portion 51 relative to the second rod member 4 attached to the second portion 52 is suppressed.

The tilting speed suppressing mechanism 55 may have a pushing member 58 (for example, a spring 58a) that causes a pressure to act between the friction plate 56 and the pressing member 57. Further, the tilting speed suppressing mechanism 55 may have a pressure adjustment part 59 (for example, a pressure adjustment handle 59a) used for adjusting the pressure acting between the friction plate 56 and the pressing member 57. In the example illustrated in FIG. 8, when the pressure adjustment handle 59a is manipulated in the first manipulation direction, the pressing member 57 is advanced in a direction toward the friction plate 56, and the spring 58a is compressed. In such a way, the pressure acting between the friction plate 56 and the pressing member 57 is increased. In contrast, when the pressure adjustment handle 59a is manipulated in the second manipulation direction opposite to the first manipulation direction, the pressing member 57 is moved in a direction away from the friction plate 56, and the amount of compression of the spring 58a becomes smaller. In such a way, the pressure acting between the friction plate 56 and the pressing member 57 is reduced.

In the example illustrated in FIG. 8, the pressing member 57 has a pressing part 57a, which presses the friction plate 56, and a threaded rod 57b, which connects the pressing part 57a and the pressure adjustment handle 59a to each other. Further, in the example illustrated in FIG. 8, a guide member 515 screwed onto the threaded rod 57b and configured to guide the motion of the threaded rod 57b, is provided to the first portion 51. In such a case, when the pressure adjustment handle 59a and the threaded rod 57b are rotated relative to the guide member 515, the pressing member 57 is moved in a direction toward the friction plate 56 (otherwise, a direction away from the friction plate 56). In such a way, the pressure acting between the friction plate 56 and the pressing member 57 is adjusted.

As illustrated in FIG. 9 as an example, the first connection part 5 (more specifically, the second portion 52) may have a shaft 525 supporting the friction plate 56. In the example illustrated in FIG. 9, the friction plate 56 is supported by the shaft 525 so as to be not rotatable with respect to the shaft 525 and to be slidingly movable along the axis direction of the shaft 525 (see the arrow AR2). When the friction plate 56 is slidingly moved along the axis of the shaft 525, the pushing force of the pushing member 58 (more specifically, the amount of compression of the spring 58a) is changed.

When the first connection part 5 includes the tilting speed suppressing mechanism 55, the tool 2 is prevented from being tilted at a high angular speed about the second axis AX2 together with the first rod member 3 even when the operator releases its hand from the first rod member 3. This ensures safety for the operator and prevents damage of the tool 2 or other members due to collision between the tool 2 and other members.

### Pivoting of First Rod Member 3 About Central Axis AT1 of First Rod Member 3

As illustrated in FIG. 10 as an example, the first rod member 3 may be supported by the first connection part 5 so as to be rotatable about the central axis AT1 of the first rod member 3 (see the arrow AR3). In such a case, the extending direction of the first axis AXI can be changed in any direction within a plane perpendicular to the central axis AT1. Thus, the extending direction of the first axis AX1 can be adjusted in accordance with the position or the orientation of the target D.

In the example illustrated in FIG. 11, adjustment of the rotation angle of the first rod member 3 about the central axis AT1 of the first rod member 3 can be manually performed. More specifically, in the example illustrated in FIG. 11, the tool device 1B is provided to the first connection part 5 and has a holding part 60, which can hold the first rod member 3, and a first manipulation part 61, which changes the state of the holding part 60. The first manipulation part 61 changes the state of the holding part 60 between a first state where the first rod member 3 is held by the holding part 60 and a second state where holding of the first rod member 3 by the holding part 60 is released.

When the state of the holding part 60 is the first state, the rotation of the first rod member 3 about the central axis AT1 of the first rod member 3 is prevented by the holding part 60. In contrast, when the state of the holding part 60 is the second state, the rotation of the first rod member 3 about the central axis AT1 of the first rod member 3 is allowed.

In this specification, illustration (a) in FIG. 12 may be referred to as FIG. 12(a), illustration (b) in FIG. 12 may be referred to as FIG. 12(b) and illustration (c) in FIG. 12 may be referred to as FIG. 12(c). The state of the holding part 60 is switched to the second state by the first manipulation part 61 being manually manipulated (see FIG. 12(c)). Further, when the state of the holding part 60 is the second state, adjustment of the rotation angle of the first rod member 3 about the central axis AT1 of the first rod member 3 is performed by the first rod member 3 being manually rotated about the central axis AT1.

In the example illustrated in FIG. 11, the first manipulation part 61 is an manipulation part that, when gripped by the operator, switches the state of the holding part 60 from the first state to the second state. The first manipulation part 61 may have a first lever 61a and a second lever 61b movable relative to the first lever 61a. In the example illustrated in FIG. 11, when the first manipulation part 61 is manipulated so that the spacing between the first lever 61a and the second lever 61b is reduced, the state of the holding part 60 is switched from the first state to the second state.

In the example illustrated in FIG. 12, the holding part 60 has a first holding member 60a and a second holding member 60b movable relative to the first holding member 60a. When the spacing between the first holding member 60a and the second holding member 60b is reduced, the first rod member 3 is held by the holding part 60 (see FIG. 12(a) and FIG. 12(b)). In contrast, when the spacing between the first holding member 60a and the second holding member 60b is expanded, holding of the first rod member 3 by the holding part 60 is released (see FIG. 12(c)). In the example illustrated in FIG. 12, when the first manipulation part 61 is gripped, the spacing between the first holding member 60a and the second holding member 60b is expanded, and the state of the holding part 60 is switched from the first state to the second state.

In the example illustrated in FIG. 12, the tool device 1B has a pushing member 62 (for example, a spring) that causes pushing force to act on the holding part 60 or the first manipulation part 61 so that the state of the holding part 60 is maintained in the first state. In the example illustrated in FIG. 12, the pushing member 62 is arranged between the first lever 61a and the second lever 61b.

When the first manipulation part 61 is provided that switches the state of the holding part 60 between the first state where the first rod member 3 is held by the holding part 60 and the second state where the holding of the first rod member 3 by the holding part 60 is released, adjustment of the rotation angle of the first rod member 3 about the central axis AT1 of the first rod member 3 and maintaining of this rotation angle can be easily performed. Further, when the tool device 1B has the pushing member 62 that causes pushing force to act on the holding part 60 or the first manipulation part 61, the state of the holding part 60 is maintained in the first state, and the rotation angle of the first rod member 3 about the central axis AT1 of the first rod member 3 is maintained by the hand being simply released from the first manipulation part 61.

Note that, although the adjustment of the rotation angle of the first rod member 3 about the central axis AT1 of the first rod member 3 is manually performed in the example illustrated in FIG. 10 and FIG. 11, the adjustment of this rotation angle may be performed by using a motor.

### Fall Prevention Member 64

In the example illustrated in FIG. 12(c), the first connection part 5 has a fall prevention member 64 that prevents the first rod member 3 from falling off of the first connection part 5 when the state of the holding part 60 is the second state. For example, the fall prevention member 64 is arranged so as to surround the first rod member 3. When the state of the holding part 60 is the second state, the fall prevention member 64 allows relative motion between the holding part 60 and the first rod member 3. To allow relative motion between the holding part 60 and the first rod member 3, it is preferable that a clearance be formed between the inner face 64n of the fall prevention member 64 and the outer face of the first rod member 3.

### Second Lock Mechanism 66

As illustrated in FIG. 11 as an example, the tool device 1B may have a second lock mechanism 66 that prevents the spacing between the first lever 61a and the second lever 61b from being reduced and a second unlocking manipulation part 67 that unlocks locking applied by the second lock mechanism 66.

In the example illustrated in FIG. 12(a), the second lock mechanism 66 has a screw member 66a that prevents the spacing between the first lever 61a and the second lever 61b from being reduced, and the second unlocking manipulation part 67 has a pinch part 67a used for rotating and manipulating the screw member 66a. In the example illustrated in FIG. 12(a), the screw member 66a is screwed into the first lever 61a.

In a state where the tip of the screw member 66a is in contact with the second lever 61b, it is not possible to reduce the spacing between the first lever 61a and the second lever 61b (see FIG. 12(a)). In other words, the state where the tip of the screw member 66a is in contact with the second lever 61b corresponds to the locked state where a reduction of the spacing between the first lever 61a and the second lever 61b is prevented.

In the example illustrated in FIG. 12(a), when the second unlocking manipulation part 67 (more specifically, the pinch part 67a) is rotated and manipulated, the tip of the screw member 66a is spaced apart from the second lever 61b (see FIG. 12(b)). In the state where the tip of the screw member 66a is spaced apart from the second lever 61b, the spacing between the first lever 61a and the second lever 61b can be reduced. In other words, the state where the tip of the screw member 66a is spaced apart from the second lever 61b corresponds to the unlocked state where a reduction of the spacing between the first lever 61a and the second lever 61b is allowed.

When the first manipulation part 61 (more specifically, the first lever 61a and the second lever 61b) is gripped by the operator in an unlocked state (in other words, a state where locking applied by the second lock mechanism 66 is released), the state of the holding part 60 is switched from the first state (see FIG. 12(b)) to the second state (see FIG. 12(c)).

Note that, in the example illustrated in FIG. 12(a), the second lock mechanism 66 can maintain the state of the holding part 60 in the first state (that is, the first state where the first rod member 3 is held by the holding part 60) by larger force than the pushing force from the pushing member 62. More specifically, the force to maintain the state of the holding part 60 in the first state can be increased by the second unlocking manipulation part 67 (more specifically, the pinch part 67a) being rotated and manipulated so that the screw member 66a presses the second lever 61b. Because the force to maintain the state of the holding part 60 in the first state is increased, unintended relative motion of the first rod member 3 with respect to the holding part (more specifically, slide motion with respect to the holding part 60 or relative rotation with respect to the holding part 60) is more reliably prevented.

In the example illustrated in FIG. 12(a) and FIG. 12(b), the second lock mechanism 66 can switch the state from a state where the level of force to maintain the state of the holding part 60 in the first state is substantially the same as the level of the pushing force from the pushing member 62 (see FIG. 12(b)) to a state where the level of force to maintain the state of the holding part 60 in the first state is larger than the level of the pushing force from the pushing member 62 (see FIG. 12(a)).

### Slide Motion of First Rod Member 3

As illustrated in FIG. 10 as an example, the first rod member 3 may be supported by the first connection part 5 so as to be slidingly movable with respect to the first connection part 5 along the longitudinal direction of the first rod member 3 (see the arrow AR4). In such a case, it is possible to adjust the distance from the first connection part 5 to the distal end 3a of the first rod member 3. For example, when it is difficult to cause the tool 2 to approach the target D by only the expansion and contraction movement of the first rod member 3, slide motion of the first rod member 3 with respect to the first connection part 5 and the expansion and contraction movement of the first rod member 3 may be combined to cause the tool 2 to approach the target D.

In the example illustrated in FIG. 11, slide motion of the first rod member 3 with respect to the first connection part 5 is manually performed. More specifically, when the first manipulation part 61 is manually manipulated, the state of the holding part 60 is switched from the first state described above to the second state described above. Further, when the state of the holding part 60 is the second state, by the first rod member 3 being manually moved along the longitudinal direction of the first rod member 3, the first rod member 3 is slidingly moved with respect to the first connection part 5.

### Pivoting of First Rod Member 3 About Central Axis AT2 of Second Rod Member 4

In this specification, illustration (a) in FIG. 13 may be referred to as FIG. 13(a) and illustration (b) in FIG. 13 may be referred to as FIG. 13(b). In the example illustrated in FIG. 10, the first rod member 3 is supported by the second rod member 4 via the first connection part 5 so as to be rotatable about the central axis AT2 of the second rod member 4 (see the arrow AR5). In such a case, the position of the tool 2 attached to the distal end 3a of the first rod member 3 can be changed within a plane perpendicular to the central axis AT2 (see FIG. 13(a)). More specifically, it is possible to change the position in planar view of the tool 2 attached to the distal end 3a of the first rod member 3.

The angular position of the first rod member 3 about the central axis AT2 of the second rod member 4 can also be maintained by a lock member. Alternatively, no lock member that maintains this angular position may be provided.

It is preferable that the rotation of the first rod member 3 about the central axis AT2 of the second rod member 4 can be manually performed. Because this rotation can be manually performed, it is possible to quickly adjust the position of the tool 2 about the central axis AT2 of the second rod member 4. In the embodiment, however, it is not excluded that the rotation of the first rod member 3 about the central axis AT2 is performed by using a motor.

The variable angle of the first rod member 3 about the central axis AT2 of the second rod member 4 is preferably 180 degrees or greater. The first rod member 3 may be revolvable by 360 degrees about the central axis AT2 of the second rod member 4.

For example, by revolving the first rod member 3 by 180 degrees about the central axis AT2 of the second rod member 4, it is possible to move the tool 2 located outside a bucket B1 of an aerial work platform (see FIG. 13(a)) in planar view to a location near the bucket B of the aerial work platform (or inside the bucket B1 of the aerial work platform (see FIG. 13(b)) in planar view. In such a case, since the tool 2 comes close to the operator located inside the bucket B1, the adjustment operation on the tool 2 by the operator (for example, such as an operation to attach another tool to the tool 2) is facilitated.

### Expansion and Contraction of Second Rod Member 4

As illustrated in FIG. 10 as an example, it is preferable that the second rod member 4 be expandable (see the arrow AR6). When the second rod member 4 is expandable, the position of the first rod member 3 in the height direction can be adjusted. For example, when the target D is at a high position, the second rod member 4 may be expanded, and the first rod member 3 and the tool 2 supported by the first rod member 3 may be moved upward.

Further, when the second rod member 4 is contracted, the first rod member 3 comes close to a proximal end 4b of the second rod member 4. In such a case, carrying the tool device 1B is facilitated. Further, since the first rod member 3 and the tool 2 supported by the first rod member 3 come close to the operator, an adjustment operation on the tool 2 by the operator (for example, such as an operation to attach another tool to the tool 2) is facilitated.

As illustrated in FIG. 10 as an example, the tool device 1B may include a fourth motor MT4 used for expanding and contracting the second rod member 4. Driving of the fourth motor MT4 is performed based on instructions from the remote controller C, for example. In other words, the tool device 1B may include a third communication unit 47 that can communicate with the remote controller C and a third control circuit 48 that controls the fourth motor MT4 based on signals received from the remote controller C by the third communication unit 47. The expansion and contraction of the second rod member 4 may be performed manually instead of being performed by using the drive force of the fourth motor MT4.

In this specification, illustration (a) in FIG. 14 may be referred to as FIG. 14(a), and illustration (b) in FIG. 14 may be referred to as FIG. 14(b). In the example illustrated in FIG. 14(b), the second rod member 4 has a third shaft 41 having a proximal end 4b and a fourth shaft 42 having a distal end 4a. A part of the fourth shaft 42 has been inserted inside the third shaft 41. Further, the fourth shaft 42 is movable relative to the third shaft 41 in a direction parallel to the central axis AT2 of the second rod member 4 by the driving of the fourth motor MT4 (otherwise, manually).

In the example illustrated in FIG. 14(b), a part of the third shaft 41 and a part of the fourth shaft 42 are overlapped with each other, and no other shaft is arranged between the third shaft 41 and the fourth shaft 42. In other words, the second rod member 4 is formed of two shafts. In such a case, the length of the second rod member 4 is a length obtained by subtracting the length of the overlapping portion between the third shaft 41 and the fourth shaft 42 from the sum of the length of the third shaft 41 and the length of the fourth shaft 42. Alternatively, the second rod member 4 may be a rod member that is expandable in multiple steps (in other words, the second rod member 4 may be formed of three or more shafts that are movable relative to each other).

The expansion and contraction of the second rod member 4 by driving of the fourth motor MT4 may be performed by using a ball screw mechanism, may be performed by using a rack and pinion, or may be performed by using other mechanisms.

FIG. 14(a) illustrates a state where the second rod member 4 is most contracted, and FIG. 14(b) illustrates a state where the second rod member 4 is most expanded. The difference between the length of the second rod member 4 in the most expanded state and the length of the second rod member 4 in the most contracted state (in other words, the telescopic stroke L2 of the second rod member 4) is preferably 10 cm or greater, 20 cm or greater, or 30 cm or greater. Further, the telescopic stroke L2 is preferably, for example, 300 cm or less, 200 cm or less, or 100 cm or less.

In the example illustrated in FIG. 14(a), the tool device 1B has a third battery E3 that supplies power to the fourth motor MT4. When the tool device 1B includes the third communication unit 47 and the third control circuit 48, the third battery E3 supplies power to the third communication unit 47 and the third control circuit 48 in addition to the fourth motor MT4.

### Base 7 and Second Connection Part 8

As illustrated in FIG. 10 as an example, the tool device 1B may include a base 7 and a second connection part 8 connecting the second rod member 4 and the base 7 to each other.

The base 7 is fixed to a fixing target B (for example, the bucket Bl of an aerial work platform). In the example illustrated in FIG. 10, the base 7 has a base body 71 and a pressing member 72 movable relative to the base body 71. The base body 71 and the pressing member 72 form a fixing part 70 used for fixing the base 7 to the fixing target B.

The base 7 may have a pressing member manipulation part 73 (for example, a handle 73a) used for moving the pressing member 72. In the example illustrated in FIG. 10, when the pressing member manipulation part 73 (more specifically, the handle 73a) is manipulated, the spacing between the pressing member 72 and the base body 71 is reduced, and the fixing target B is held between the pressing member 72 and the base body 71. In such a way, the base 7 is fixed to the fixing target B. Note that the configuration of the fixing part 70 that fixes the base 7 to the fixing target B may be any configuration without being limited to the example illustrated in FIG. 10. In other words, the base 7 can be fixed to the fixing target B in any manner.

When the tool device 1B includes the base 7 that supports the second rod member 4, the second rod member 4 is stably supported by the base 7. Further, when the base 7 is fixed to the fixing target B, the second rod member 4 is stably supported by the base 7 and the fixing target B.

In this specification, illustration (a) in FIG. 15 may be referred to as FIG. 15(a), and illustration (b) in FIG. 15 may be referred to as FIG. 15(b). In the example illustrated in FIG. 15(a), the second connection part 8 connects the second rod member 4 and the base 7 to each other so that the second rod member 4 is movable in a first direction DR1 (for example, the horizontal direction) perpendicular to the longitudinal direction of the second rod member 4 with respect to the base 7 (see the arrow AR7).

The second connection part 8 has a third portion 81 attached to the second rod member 4 and a fourth portion 82 attached to the base 7. Further, the third portion 81 is coupled to the fourth portion 82 so as to be movable relative to the fourth portion 82 in the first direction DR1. In the example illustrated in FIG. 15(a), the third portion 81 is formed of a plurality of components, and the fourth portion 82 is formed of a plurality of components.

In the example illustrated in FIG. 15(a), the third portion 81 has a support part 811 supporting the second rod member 4 and a slider 812 connected to the support part 811 and movable in the first direction DR1. The slider 812 may have a plurality of rollers 812a.

In the example illustrated in FIG. 15(a), the fourth portion 82 has a guide member 822 that guides motion of the slider 812 in a direction along the first direction DR1. The guide member 822 may include a guide rail 822a that guides the motion of a plurality of rollers 812a.

As illustrated in FIG. 15(a) as an example, the second connection part 8 may have a motion manipulation part 84 that moves the third portion 81 in the first direction DR1. For example, the motion manipulation part 84 is formed of a handle 84a. In the example illustrated in FIG. 15(a), when the motion manipulation part 84 (more specifically, the handle 84a) is manipulated in the first manipulation direction, the third portion 81 is relatively moved in the first direction DR1 with respect to the fourth portion 82. In contrast, in the example illustrated in FIG. 15(b), when the motion manipulation part 84 is manipulated in a second manipulation direction, which is opposite to the first manipulation direction, the third portion 81 is relatively moved in the second direction DR2, which is opposite to the first direction DR1, with respect to the fourth portion 82.

In the example illustrated in FIG. 15(a), a threaded rod 85 is coupled to the motion manipulation part 84, and the external thread part of the threaded rod 85 is screwed into the internal thread part of the third portion 81. In such a case, when the motion manipulation part 84 is rotated and manipulated, the threaded rod 85 is rotated about the axis of the threaded rod 85. When the threaded rod 85 is rotated about the axis of the threaded rod 85, the third portion 81 is moved along the threaded rod 85. In such a way, the third portion 81 and the second rod member 4 attached to the third portion 81 are moved in the first direction DR1.

In the example illustrated in FIG. 15(a), the mechanism that moves the third portion 81 includes the external thread part of a threaded rod 85, the internal thread part of the third portion 81, the guide rail 822a, and a slider 812. Alternatively, one of the set of the external thread part of the threaded rod 85 and the internal thread part of the third portion 81 and the set of the guide rail 822a and the slider 812 may be omitted. Further, alternatively, the mechanism that moves the third portion 81 may include a rack and pinion instead of the external thread part and the internal thread part.

When the tool device 1B includes the second connection part 8 described above connecting the second rod member 4 and the base 7 to each other, the tool device 1B can easily adjust the position of the second rod member 4 in the horizontal direction.

Although the second rod member 4 can be moved laterally (in other words, in a direction parallel to the first direction DR1) with respect to the base 7 in the example illustrated in FIG. 15, the second rod member 4 may be unable to be moved laterally with respect to the base 7. Further, although the relative motion of the second rod member 4 with respect to the base 7 is performed manually in the example illustrated in FIG. 15, the relative motion of the second rod member 4 with respect to the base 7 may be performed by using a motor.

### First Grip Part 25a and Second Grip Part 25b

In the example illustrated in FIG. 2 or FIG. 10, the tool 2 includes the gripping mechanism G1 that can grip a force application target. Further, this gripping mechanism G1 includes a first grip part 25a and a second grip part 25b movable relative to the first grip part 25a.

In the example illustrated in FIG. 2 or FIG. 10, the gripping mechanism G1 is supported by the arm 22. Further, the gripping mechanism G1 forms at least a part of the end effector 25 that causes force to act on the force application target. In other words, the end effector 25 includes the gripping mechanism G1. In the example illustrated in FIG. 2 or FIG. 10, the second grip part 25b is driven by the end effector drive device M1 and thereby moved relative to the first grip part 25a.

In the example illustrated in FIG. 2 or FIG. 10, the tool device 1 (more specifically, the tool 2) includes the arm drive device AM that pivots the arm 22 with respect to the attachment part 21 and the end effector drive device M1 that drives the second grip part 25b. In such a case, for example, it is possible to cause desired gripping force to act on the target D, which is a force application target, by using the arm drive device AM to pivot the arm 22 with respect to the attachment part 21, thereby causing the tool 2 to approach the target D, and then using the end effector drive device M1 to drive the second grip part 25b. Alternatively, another tool may be caused to approach the target D such as an electrical wire by driving the end effector drive device M1 to move the second grip part 25b, thereby causing the gripping mechanism G1 to grip that another tool, which is the force application target, and then using the arm drive device AM to pivot the arm 22 with respect to the attachment part 21.

In the example illustrated in FIG. 2 or FIG. 10, the tool 2 has a threaded rod 201 screwed into the internal thread part of the second grip part 25b and a guide shaft 202 configured to guide motion of the second grip part 25b. In such a case, the end effector drive device M1 (more specifically, the first motor MT1) rotates the threaded rod 201 in the first rotation direction, and thereby the second grip part 25b screwed onto the threaded rod 201 is moved in a direction closer to the first grip part 25a. Further, the end effector drive device M1 (more specifically, the first motor MT1) rotates the threaded rod 201 in the second rotation direction opposite to the first rotation direction, and thereby the second grip part 25b screwed onto the threaded rod 201 is moved in a direction away from the first grip part 25a.

In the example illustrated in FIG. 2 or FIG. 10, the first grip part 25a is a fixed grip part not driven by the end effector drive device M1, and the second grip part 25b is a movable grip part driven by the end effector drive device M1. Alternatively, the first grip part 25a and the second grip part 25b may be connected via a link mechanism, and thereby the end effector drive device M1 may drive both the first grip part 25a and the second grip part 25b. In other words, both the first grip part 25a and the second grip part 25b may be movable grip parts. Further, any attachment may be attached to the first grip part 25a and/or the second grip part 25b in accordance with a condition such as the shape of the force application target gripped by the gripping mechanism G1. Further, alternatively, the tool 2 may have a first blade member instead of the first grip part 25a and have a second blade member driven by the end effector drive device M1 instead of the second grip part 25b. In other words, the tool 2 may be a cutting tool having the first blade member and the second blade member.

### Rotating Body 25c

As illustrated in FIG. 16 as an example, in the first embodiment, the second embodiment, or the third embodiment described later, the tool 2 may have a rotating body 25c driven by the end effector drive device M1 (more specifically, the first motor MT1) and rotatable about the first rotation axis AS1.

In the example illustrated in FIG. 16, the rotating body 25c is supported by the arm 22. Further, the rotating body 25c forms at least a part of the end effector 25 that causes force to act on the force application target. In other words, the end effector 25 includes the rotating body 25c. In such a case, for example, it is possible to cause rotation force to act on the target D, which is the force application target, by using the arm drive device AM to pivot the arm 22 with respect to the attachment part 21, thereby causing the tool 2 to approach the target D, and then using the end effector drive device M1 to drive and rotate the rotating body 25c.

In the example illustrated in FIG. 16, the tool 2 has a shaft 203 that couples the end effector drive device M1 (more specifically, the first motor MT1) and the rotating body 25c to each other. In such a case, the end effector drive device M1 (more specifically, the first motor MT1) rotates the shaft 203, and thereby the rotating body 25c is rotated about the first rotation axis AS1.

In the example illustrated in FIG. 16, the rotating body 25c has a hook 251c. In such a case, for example, the tip of the hook 251c is inserted in a manipulation ring of another tool, then the hook 251c is rotated about the first rotation axis AS1, and thereby the manipulation ring of that another tool is manipulated and rotated by the hook 251c. Alternatively, the rotating body 25c may have a driver engageable with a part such as the head of a screw member or may have a spanner engageable with a part such as the head of a nut or a bolt. Further, alternatively, the rotating body 25c may have a blade member used for separating a covering layer of an electrical wire from a core wire of the electrical wire.

### Multiple End Effectors (25, 25′)

In the first embodiment, the second embodiment, or the third embodiment described later, the tool 2 may include a plurality of end effectors (25, 25′) driven by the end effector drive device M1.

In the example illustrated in FIG. 17, the tool 2 has a first end effector 25 and a second end effector 25′, and the end effector drive device M1 has the first motor MT1 and a second motor MT2. Driving of the first motor MT1 is controlled by the control circuit 28 based on a manipulation signal from the remote controller C, for example, and driving of the second motor MT2 is controlled by the control circuit 28 based on a manipulation signal from the remote controller C, for example.

In the example illustrated in FIG. 17, the first end effector 25 includes the gripping mechanism G1. The second grip part 25b of the gripping mechanism G1 is driven by the first motor MT1 and thereby moved relative to the first grip part 25a. In the example illustrated in FIG. 17, the second end effector 25′ includes the rotating body 25c. The rotating body 25c is driven by the second motor MT2 and thereby rotated about the first rotation axis AS1. The rotating body 25c may include the hook 251c, may include a driver, may include a spanner, or may include a blade member.

When the tool 2 has a plurality of end effectors (25, 25′), it is possible to perform a plurality of different operations by using a single tool device 1. For example, an operation performed by using the first end effector 25 and an operation performed by using the second end effector 25′ can be selectively or continuously performed.

### Tool Holding Part 23

In the example illustrated in FIG. 2 or FIG. 10, the tool 2 includes a tool holding part 23 provided separately from the end effector 25 and configured to hold another tool in a detachable manner (in other words, a tool holding part 23 configured to hold another tool in a replaceable manner). The tool holding part 23 can selectively hold tools such as a hook 24 (see FIG. 18), a driver, a spanner, a sleeve compressing tool, or the like.

When the tool 2 includes the tool holding part 23, any tool can be attached to the tool holding part 23, and this tool can be moved to approach the target D with the use of the first rod member 3 and the arm 22. Further, when the tool 2 includes the end effector 25 and the tool holding part 23, an operation performed by using the end effector 25 and an operation performed by using a tool held by the tool holding part 23 can be selectively or continuously performed.

### Third Embodiment

The tool 2 of the third embodiment will be described with reference to FIG. 1 to FIG. 19. FIG. 19 is a general side view schematically illustrating the tool 2 of the third embodiment.

In the third embodiment, features different from the first embodiment and the second embodiment will be mainly described, and duplicated description for features that have already been described in the first embodiment or the second embodiment will be omitted. It is therefore obvious that, even when not explicitly described in the third embodiment, the features that have already been described in the first embodiment or the second embodiment can be employed in the third embodiment.

As illustrated in FIG. 19 as an example, the tool 2 of the third embodiment includes (1) the attachment part 21 that can be attached to a rod member, (2) the arm 22 supported pivotably by the attachment part 21, (3) the end effector 25 supported by the arm 22 and configured to cause force to act on a force application target, (4) the arm drive device AM configured to pivot the arm 22 with respect to the attachment part 21, and (5) the end effector drive device M1 configured to drive the end effector 25.

The tool 2 of the third embodiment may have the same configuration as the tool 2 of the tool device 1A of the first embodiment or may have the same configuration as the tool 2 of the tool device 1B of the second embodiment. For each configuration of the tool 2 (for example, the attachment part 21, the arm 22, the end effector 25, the tool holding part 23, the communication unit 27, the control circuit 28, the first battery E1, and the like), the description thereof in the first embodiment or the second embodiment will apply, and duplicated description for each configuration of the tool 2 will be omitted.

### Method of Using Tool Device 1

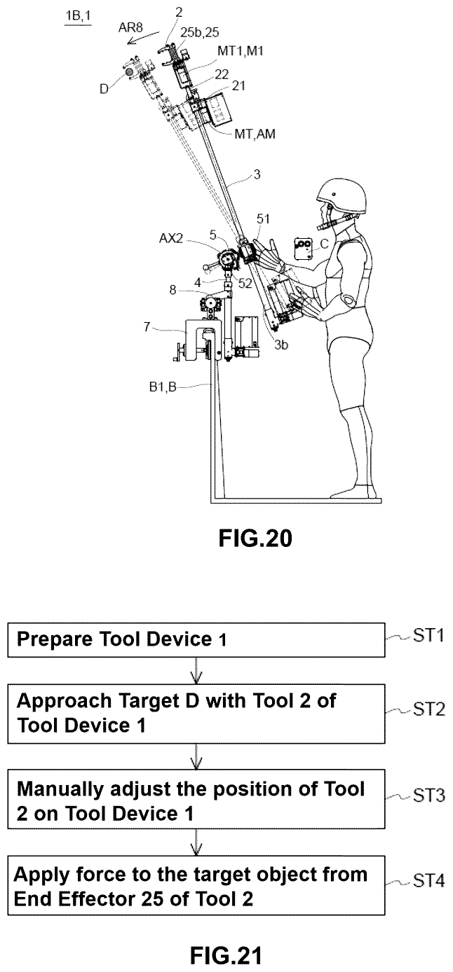

Next, a method of using the tool device 1 of the embodiment will be described with reference to FIG. 1 to FIG. 21. FIG. 20 is a diagram schematically illustrating a view during a position adjustment step being performed. FIG. 21 is a flowchart illustrating an example of the method of using the tool device 1 of the embodiment.

The tool device 1 used in the method of using the tool device 1 of the embodiment may be the tool device 1A of the first embodiment, may be the tool device 1B of the second embodiment, or may be other tool devices.

The tool device 1 includes (1) the expandable first rod member 3 and (2) the tool 2 attached to the first rod member 3. The tool 2 includes (3) the attachment part 21 attached to the first rod member 3, (4) the arm 22 supported pivotably by the attachment part 21, (5) the end effector 25 supported by the arm 22, (6) the arm drive device AM configured to pivot the arm 22 with respect to the attachment part 21, and (7) the end effector drive device M1 configured to drive the end effector 25. (8) The tool device 1 may have the second rod member 4 and the first connection part 5 connecting the first rod member 3 and the second rod member 4 to each other. (9) The tool device 1 may have the holding part 60 that can hold the first rod member 3 and the first manipulation part 61 that changes the state of the holding part 60. (10) The tool device 1 may have the third motor MT3 that expands and contracts the first rod member 3 and/or the fourth motor MT4 that expands and contracts the second rod member 4. (11) The tool device 1 may have the base 7 and the second connection part 8 connecting the second rod member 4 and the base 7 to each other. Since “first rod member 3”, “tool 2”, “second rod member 4”, “first connection part 5”, “holding part 60”, “first manipulation part 61”, “third motor MT3”, “fourth motor MT4”, “base 7”, and “second connection part 8” have already been described in the first embodiment or the second embodiment, duplicated description for these configurations will be omitted.

In the first step ST1, the tool device 1 is prepared. The first step ST1 is a preparation step. The tool device 1 prepared in the preparation step may be the tool device 1A of the first embodiment, may be the tool device 1B of the second embodiment, or may be other tool devices.

When the tool 2 and the first rod member 3 are separated from each other, the preparation step (first step ST1) may include attaching the attachment part 21 of the tool 2 to the distal end 3a of the first rod member 3. Further, when the tool device 1 includes the base 7, the preparation step (first step ST1) may include fixing the base 7 to the fixing target B (for example, the bucket B1 of the aerial work platform). Further, when the tool device 1 includes the tool holding part 23, the preparation step (first step ST1) may include attaching another tool (for example, the hook 24, a driver, a spanner, a sleeve compressing tool, or the like) to the tool holding part 23. Further, in the tool device 1, when the end effector can be replaced with another end effector 25, the preparation step (first step ST1) may include replacing the end effector arranged in the tool 2 with that another end effector 25.

In the second step ST2, the tool 2 attached to the distal end 3a of the first rod member 3 is caused to approach the target D. The second step ST2 is an approach step. The approach step includes causing the tool 2 to approach the target D by performing at least one of: expanding the first rod member 3 (see FIG. 3); and using the arm drive device AM (more specifically, the arm drive motor MT) to pivot the arm 22 with respect to the attachment part 21 (see FIG. 2).

For example, pivoting of the arm 22 is performed by the arm drive device AM driving the arm 22 based on the first manipulation signal from the remote controller C. Expansion of the first rod member 3 may be performed by the third motor MT3 moving the second shaft 32 of the first rod member 3 with respect to the first shaft 31 based on the third manipulation signal from the remote controller C or may be performed manually.

When the tool device 1 includes the second rod member 4 connected to the first rod member 3 via the first connection part 5, the approach step (second step ST2) may include expanding the second rod member 4 (see the arrow AR6 in FIG. 14). The expansion of the second rod member 4 may be performed by the fourth motor MT4 moving the fourth shaft 42 of the second rod member 4 with respect to the third shaft 41 based on the fourth manipulation signal from the remote controller C or may be performed manually.

When the tool device 1 includes the second rod member 4 connected to the first rod member 3 via the first connection part 5, the approach step (second step ST2) may include slidingly moving the entire first rod member 3 with respect to the first connection part 5 (see the arrow AR4 in FIG. 11). Slidingly moving the entire first rod member 3 may be performed by using drive force of a motor or may be performed manually.

In the example illustrated in FIG. 11, the approach step (second step ST2) includes (1) in response to the first manipulation part 61 being manipulated, changing the state of the holding part 60 from the first state where the first rod member 3 is held by the holding part 60 to the second state where the holding of the first rod member 3 by the holding part 60 is released, (2) in this second state, the entire first rod member 3 being slidingly moved with respect to the first connection part 5 (see the arrow AR4), and (3) in response to the first manipulation part 61 being manipulated (more specifically, in response to the hand being released from the first manipulation part 61), changing the state of the holding part 60 from the second state to the first state where the first rod member 3 is held by the holding part 60.

When the tool device 1 includes the second rod member 4 connected to the first rod member 3 via the first connection part 5, the approach step (second step ST2) may include relatively rotating the first rod member 3 about the central axis AT1 of the first rod member 3 with respect to the first connection part 5 (see the arrow AR3 in FIG. 11). Rotating the first rod member 3 about the central axis AT1 may be performed by using the drive force of a motor or may be performed manually.

In the example illustrated in FIG. 11, the approach step (second step ST2) includes (1) in response to the first manipulation part 61 being manipulated, changing the state of the holding part 60 from the first state described above to the second state described above, (2) in this second state, the first rod member 3 being relatively rotated about the central axis AT1 of the first rod member 3 with respect to the first connection part 5 (see the arrow AR3), and (3) in response to the first manipulation part 61 being manipulated (more specifically, in response to the hand being released from the first manipulation part 61), changing the state of the holding part 60 from the second state described above to the first state described above.

When the second rod member 4 is an expandable rod member, the approach step (second step ST2) may include expanding the second rod member 4 (see FIG. 14). The expansion of the second rod member 4 may be performed by the fourth motor MT4 being driven based on the fourth manipulation signal from the remote controller C or may be performed manually.

When the tool device 1 includes the base 7 connected to the second rod member 4 via the second connection part 8, the approach step (second step ST2) may include relatively moving the entire second rod member 4 in a direction perpendicular to the second rod member 4 with respect to the base 7 (see FIG. 15). The relatively moving the entire second rod member 4 with respect to the base 7 may be performed with the use of drive force of a motor or may be performed manually.

In the third step ST3, in response to the first rod member 3 being manipulated manually, the position of the tool 2 attached to the distal end 3a of the first rod member 3 is adjusted. The third step ST3 is a position adjustment step. The position adjustment step may be performed after the approach step (second step ST2), may be performed at the same time as the approach step (second step ST2), or may be performed before the approach step (second step ST2).

The position adjustment step (third step ST3) may include manually changing the angle between the first rod member 3 and the second rod member 4. The changing the angle between the first rod member 3 and the second rod member 4 may include moving the proximal end 3b of the first rod member 3 to rotate the first rod member 3 about the second axis AX2 (see the arrow AR8 in FIG. 20).

The position adjustment step (third step ST3) may include manually rotating the first rod member 3 about the central axis AT2 of the second rod member 4 (see FIG. 13(a)). The rotating the first rod member 3 about the central axis AT2 may be performed by manual motion of the proximal end 3b of the first rod member 3.

In the fourth step ST4, force is applied to a force application target from the end effector 25. The fourth step ST4 is a force application step. The force application step is performed by driving the end effector 25 with the use of the end effector drive device M1. When the end effector 25 has the gripping mechanism G1 (see FIG. 2, FIG. 10, or FIG. 17), gripping force is applied to the force application target from the end effector 25. Further, when the end effector 25 has the rotating body 25c (see FIG. 16 or FIG. 17), rotation force is applied to the force application target from the end effector 25. Further, when the end effector 25 has a blade member, cutting force is applied to the force application target from the end effector 25.

The application of force to the force application target from the end effector 25 is performed by the end effector drive device M1 driving the end effector 25 based on the second manipulation signal from the remote controller C, for example.

The force application step (fourth step ST4) may be performed after the approach step (second step ST2) and the position adjustment step (third step ST3). For example, when the force application target and the target D are the same (for example, when force is applied to the target D such as an electrical wire located in the air), the end effector 25 is moved closer to the target D by the approach step and the position adjustment step being performed, and force is then applied to the target D from the end effector 25 by the force application step being performed.

Alternatively, the force application step (fourth step ST4) may be performed before the approach step (second step ST2) and the position adjustment step (third step ST3). For example, when the force application target and the target D differ from each other (for example, when another tool gripped by the tool 2 is caused to act on the target D), the end effector 25 is driven to cause the tool 2 to grip another tool by the force application step being performed, and another tool gripped by the tool 2 is then moved closer to the target D by the approach step and the position adjustment step being performed.

The method of using the tool device 1 of the embodiment includes (1) performing at least one of expanding the first rod member 3 and using the arm drive device AM to pivot the arm 22 with respect to the attachment part 21, and thereby causing the tool 2 to approach the target D and (2) in response to the first rod member 3 being manually manipulated, adjusting the position of the tool 2. Thus, for example, when the position of the tool 2 did not reach a desired position near the target D by expansion of the first rod member 3 or pivoting of the arm 22 or when the position of the target D moves due to an external turbulence such as wind, the position of the tool 2 can be quickly adjusted by the first rod member 3 being manually manipulated.

It is apparent that the present invention is not limited to each embodiment or each modified example described above and each embodiment or each modified example may be modified or changed as appropriate within the scope of the technical concept of the present invention. Further, any component used in each embodiment or each modified example can be combined with another embodiment or another modified example, or any component can be omitted in each embodiment or each modified example.

### INDUSTRIAL APPLICABILITY

The use of the tool device, the tool, and the method of using the tool device of the present invention makes it possible to facilitate approach of the tool to the target. Therefore, the tool device, the tool, and the method of using the tool device of the present invention are useful for business entities that perform operations on a target by using a tool and manufacturers that manufacture tool devices or tools.

### LIST OF REFERENCE SYMBOLS

1, 1A, 1B tool device, 2 tool, 3 first rod member, 3a distal end, 3b proximal end, 4 second rod member, 4a distal end, 4b proximal end, 5 first connection part, 7 base, 8 second connection part, 21 attachment part, 22 arm, 23 tool holding part, 24 hook, 25 end effector, 25′ second end effector, 25a first grip part, 25b second grip part, 25c rotating body, 27 communication unit, 28 control circuit, 31 first shaft, 32 second shaft, 37 second communication unit, 38 second control circuit, 41 third shaft, 42 fourth shaft, 47 third communication unit, 48 third control circuit, 50 lock mechanism, 51 first portion, 52 second portion, 53 unlocking manipulation part, 54 pushing member, 55 tilting speed suppressing mechanism, 56 friction plate, 57 pressing member, 57a pressing part, 57b threaded rod, 58 pushing member, 58a spring, 59 pressure adjustment part, 59a pressure adjustment handle, 60 holding part, 60a first holding member, 60b second holding member, 61 first manipulation part, 61a first lever, 61b second lever, 62 pushing member, 64 fall prevention member, 64n inner face, 66 second lock mechanism, 66a screw member, 67 second unlocking manipulation part, 67a pinch part, 70 fixing part, 71 base body, 72 pressing member, 73 pressing member manipulation part, 73a handle, 81 third portion, 82 fourth portion, 84 motion manipulation part, 84a handle, 85 threaded rod, 201 threaded rod, 202 guide shaft, 203 shaft, 251c hook, 510 first engagement part, 510a claw, 515 guide member, 520 second engagement part, 520a gear wheel, 525 shaft, 811 support part, 812 slider, 812a roller, 822 guide member, 822a guide rail, AM arm drive device, B fixing target, B1 bucket, C remote controller, C1 arm manipulation part, C2 end effector manipulation part, D target, E1 first battery, E2 second battery, E3 third battery, G1 gripping mechanism, M1 end effector drive device, MT arm drive motor, MT1 first motor, MT2 second motor, MT3 third motor, MT4 fourth motor

1. A tool device comprising:
an expandable first rod member; and
a tool attached to the first rod member,
wherein the tool comprises
an attachment part attached to the first rod member,
an arm supported pivotably by the attachment part,
an end effector supported by the arm and configured to cause force to act on a force application target,
an arm drive device configured to pivot the arm with respect to the attachment part, and
an end effector drive device configured to drive the end effector.

2. The tool device according to claim 1, wherein the tool comprises
a communication unit configured to communicate with a remote controller, and
a control circuit configured to control the arm drive device and the end effector drive device based on a signal received by the communication unit.

3. The tool device according to claim 2,
wherein the communication unit is configured to wirelessly communicate with the remote controller,
wherein the first rod member is an electrically insulating rod member, and
wherein the tool is a tool for electrical construction.

4. The tool device according to claim 1 further comprising:
a second rod member; and
a first connection part connecting the second rod member and the first rod member to each other,
wherein the first connection part connects the second rod member and the first rod member to each other so that an angle between the first rod member and the second rod member is changeable.

5. The tool device according to claim 4, wherein the angle between the first rod member and the second rod member is manually changeable.

6. The tool device according to claim 4, wherein the first connection part comprises
a lock mechanism configured to prevent the first rod member from tilting with respect to the second rod member, and
an unlocking manipulation part configured to release locking applied by the lock mechanism.

7. The tool device according to claim 4, wherein the first connection part comprises a tilting speed suppressing mechanism configured to suppress the tilting speed of the first rod member with respect to the second rod member when the first rod member tilts with respect to the second rod member due to the gravity acting on the tool or the first rod member.

8. The tool device according to claim 4 further comprising:
a holding part provided to the first connection part and configured to hold the first rod member; and
a first manipulation part configured to change the state of the holding part between a first state where the first rod member is held by the holding part and a second state where holding of the first rod member by the holding part is released.

9. The tool device according to claim 4, wherein the first rod member is supported by the second rod member via the first connection part so as to be rotatable about the central axis of the second rod member.

10. The tool device according to claim 1,
wherein the tool comprises a gripping mechanism configured to grip the force application target,
wherein the gripping mechanism has
a first grip part, and
a second grip part driven by the end effector drive device and movable relative to the first grip part, and
wherein the end effector includes the gripping mechanism.

11. The tool device according to claim 1,
wherein the tool is driven by the end effector drive device and has a rotating body rotatable about a first rotation axis, and
wherein the end effector includes the rotating body.

12. The tool device according to claim 1,
wherein the tool comprises a tool holding part provided separately from the end effector and configured to detachably hold another tool.

13. A tool comprising:
an attachment part configured to be attached to a rod member;
an arm supported pivotably by the attachment part;
an end effector supported by the arm and configured to cause force to act on a force application target;
an arm drive device configured to pivot the arm with respect to the attachment part; and
an end effector drive device configured to drive the end effector.

14. A method of using a tool device,
wherein the tool device comprises
an expandable first rod member, and
a tool attached to the first rod member, and
wherein the tool comprises
an attachment part attached to the first rod member,
an arm supported pivotably by the attachment part,
an end effector supported by the arm,
an arm drive device configured to pivot the arm with respect to the attachment part, and
an end effector drive device configured to drive the end effector,
the method comprising:
an approach step of causing the tool to approach a target by performing at least one of: expanding the first rod member; and pivoting the arm with respect to the attachment part by using the arm drive device;
a position adjustment step of adjusting the position of the tool by the first rod member being manually manipulated; and
a force application step of applying force to a force application target from the end effector by using the end effector drive device to drive the end effector.

15. The tool device according to claim 2 further comprising:
a second rod member; and
a first connection part connecting the second rod member and the first rod member to each other,
wherein the first connection part connects the second rod member and the first rod member to each other so that an angle between the first rod member and the second rod member is changeable.

16. The tool device according to claim 3 further comprising:
a second rod member; and
a first connection part connecting the second rod member and the first rod member to each other,
wherein the first connection part connects the second rod member and the first rod member to each other so that an angle between the first rod member and the second rod member is changeable.

17. The tool device according to claim 15, wherein the angle between the first rod member and the second rod member is manually changeable.

18. The tool device according to claim 16, wherein the angle between the first rod member and the second rod member is manually changeable.

19. The tool device according to claim 15, wherein the first connection part comprises
a lock mechanism configured to prevent the first rod member from tilting with respect to the second rod member, and
an unlocking manipulation part configured to release locking applied by the lock mechanism.

20. The tool device according to claim 16, wherein the first connection part comprises
a lock mechanism configured to prevent the first rod member from tilting with respect to the second rod member, and
an unlocking manipulation part configured to release locking applied by the lock mechanism.
